(19) United States
(12) Patent Application Publication
(10) Pub. No.: US 2009/0160087 A1
(43) Pub. Date: Jun. 25, 2009

(54) IN-MOLD DECORATION METHOD & APPARATUS

(76) Inventor: Gawain Yang, Singapore (SG)

Correspondence Address: Jellett Law, PS;Matthew Jellett, Esq., 910 Harris Ave, Suite A205, BELLINGHAM, WA, 98225, US

(21) Appl. No.: 11/960,525

(22) Filed: Dec. 19, 2007

(51) Int. Cl. B29C 45/16

(52) U.S. Cl. 264/271.1

(57) ABSTRACT

A method and apparatus to form and in mold decoration part utilizing an IML/IML process or an IMD/IML process. The processes prepare inlays or decorations then load the inlays or decorations in to a mold, the decorations and inlays are formed on the inner and outer surfaces of the part with the part resin through the injection mold process, the in mold decoration part is then formed and ejected.

### BACKGROUND

US 2006/0255493 discloses an apparatus and method for making form fitted molded protective case for products. In the Summary of the Invention section starting in paragraph six, “the method and apparatus [is] for making the protective cases of form fitted thermoplastic or polycarbonate material which can be easily printed with decorative imagery and/or electronic circuitry for a variety of products, such as . . . cell phones. The method involves creating a tool [a surface replica of the product] having substantially the same surface dimensions of the product. An element [the thermoplastic polycarbonate casing] is then molded from bulk film of thermoplastic material using the tool. Once molded, the element is trimmed from the bulk film. The resulting apparatus is a protective case tinted to form fit over the surface features and dimensions of the actual product used to define the tool.”

US 2006/0231969 discloses a method for making a three-dimensional laser tag with in-mold injection, which allows a transparent membrane formed with laser figure or mark to be stamped in advance so as to make the laser figures or marks provide three-dimensional lasting shapes corresponding to the transparent membrane. As seen in the Summary of the Invention section in paragraph [007] on page 1, “the present invention [is to].allow the tag being formed three-dimensionally, to be provided with different colors, easy to [be] released and low in production cost.” Furthermore starting in paragraph [008], “the present invention includes the following steps: a laser figure or mark being roll printed on a transparent membrane with a full image technique; the transparent membrane being printed with an ink layer; a medium layer being printed on ink layer which has been printed on the transparent membrane; the membrane being treated three-dimensional stamping to form a three-dimensional shape; the three-dimensional membrane . . . treated with trimming; the component being completed with injection molding with the laser figure or the mark between the transparent membrane and the ink layer.”

US 2006/0222826 discloses an in-mold decorated molded product and method of manufacturing the same, wherein the Disclosure of the Invention section starting in paragraph [009] on page 1 includes, “an in-molded decorated molded article comprising: a transparent molded resin body . . . which includes a side face on which a side gate mark is formed; a coating layer is formed on a top surface of the transparent molded resin body, for covering an edge part of . . . a side face of the molded resin body with the side gate mark formed, in order for the side gate mark not to be seen from the top surface of the molded resin body; a decorative layer which is formed on a bottom surface molded resin body.”

As seen on page 3 in paragraph [045], “the in-mold decorated molded article is molded by using two decorative sheets for transferring the coating layer and the decorative layer . . . ” Furthermore in paragraph [051], “a major object for forming the pattern of the coating layer is not limited to an object for decorating the panel. Alternatively, the major object may be to conceal the side gate mark.”

US 2006/0123574 discloses a compression molded part, where an injection molded part having a basic body injection plastic form is decorated with a two-dimensionally applied surface and is then covered by an encapsulation of plastic by second injection molding operation. As seen in paragraph [001] on page 1, “the invention relates to an injection molded part, in particular a toothbrush body, with a basic body, injection molded from plastic, on the surface of which a decoration is two-dimensionally applied and is covered by an encapsulation of plastic by a second injection molding operation.” Furthermore in paragraph [017], with regard to printing, “to avoid damage to the tools used for applying the decoration, for example when printing the decoration on by means of a pad stamp,” and further discussion of decoration in paragraph [019], “the decoration may be formed in a wide variety of ways. For instance, the decoration may be an insert part or a hot transfer film or a metallized film. Decoration may also be applied to the surface of the basic body by printing in particular by pad printing, screen printing, laser printing or inkjet printing. To produce a complicated multilayered image, further decoration can be applied to the encapsulation covered by another or further encapsulation.”

US 2005/0271760 discloses an in-mold decoration apparatus. The decorating sheets are pinched between a fixed mold half and a movable mold half. Molten resin is injected into the mold so that the decorating sheets are bonded to the surface of a resin molded article. The in-mold decoration apparatus has a horizontal and vertical direction decorating sheet feeding machines for performing feed and take up of the decorating sheet in the vertical directions for set up within a narrow installation space. In the Summary of the Invention section as seen in paragraph [008], “an object of the present invention is to provide an in-mold decoration apparatus, which allows a decorating sheet feeding machine to be installed even with narrow installation space . . . ”

US 2003/0216125 discloses an integral part design, molding and surface finish for cosmetic appearance; the part employs internal molded shapes and surface finish to provide cosmetic features or design elements. As seen in the Summary of the Invention section in paragraph [006], “the present invention provides a part having one or more internally formed cosmetic features viewable from an external surface of the part.” Further in paragraph [007], “the present invention provides a method for manufacturing a part having one or more internally formed cosmetic features viewable from an external surface of the part. The method comprises steps of molding at least a portion of the body of a part in transparent or semitransparent material and forming the cosmetic feature in the internal surface of the body, so that the cosmetic feature is visible from the external surface.” As seen on page two in paragraph [020], “the cosmetic feature is a shape that corresponds to the shape of the internal surface of the body . . . Exemplary surface finishes include paint, ink, or etching of the surface of the shape, polishing of the surface of the shape, screen printing, in-mold decoration (IMD), and the like.”

US 2003/0122278 discloses a method for applying multiple decorative functional films to injection mold components, where the multiple decorative sheets are applied to an injection mold component as part of the injection mold process. In the Summary of the Invention section in paragraph [010], “the present invention is a method for applying images to an injection mold component. Two sheets of film having the desired images are placed in a mold for the injection mold component. Resin is injected into the mold filling the mold and forming the injection mold component. One surface of the injection mold component directly contacts the first sheet of film, and another surface of the component directly contacts the second sheet of film. As the injection mold component is allowed to solidify, the first and second sheets of film are permanently affixed to the surfaces of the injection mold component without changing the images.”.” As seen in the middle of paragraph [013], “each sheet comprises a film layer, preferably made of polycarbonate material, and an ink layer which contains images printed on the sheet.” Further down in paragraph [014] “the first sheet of film is placed in the first mold on the first mold surface and similarly the second sheet of film is placed in the second mold on the second mold surface. These sheets of film may be placed in the molds robotically.”

US 2002/0053750 discloses a method and apparatus for molding a soft trim component on substrates. Referring to page 1 paragraph [010] in the Summary of the Invention section, “under the invention, a method of making a composite article includes applying and in-mold coating to at least a first mold cavity . . . the method further including inserting, between the pair of mold halves, a substrate having a first surface including a first area, a second surface, and an aperture defining a closed path from the first area of the first surface to the second surface, where inserting includes positioning the first area of the first surface in opposition to the in-mold coating on the first mold cavity surface such that a gap is defined between the first surface of the substrate and the in-mold coating; and injecting a foam through the aperture into the gap. Because the foam is gated through the second surface, for example, a rear surface of the composite article opposite its show surface, the invention beneficially eliminates the need for trimming the gate generated foam injection.”

U.S. Pat. No. 6,875,301 discloses a method for manufacturing an injection molded product, which includes producing a first injection molded layer which has an external and internal surface, where the external surface is directed towards a front face of the injection molded product. As seem in the Summary of the Invention section in column 2 around line 54, “the invention [is] achieved by providing an injection molded layer on the outside of the decorated foil that constitutes the insert in the injection molding process, either by injection molding on top of the foil or by injection molding the product in concern in at least two injection molded layers so that decorative patterns and their carrier foil are inserted in between said layers before injection molding the latter one of them.” Furthermore in column 7 around line 4, “a method for producing the in-mold decorated product includes where there is provided a base foil which acts as the support, bonding and protective structure of the patterned foil. To prepare for the patterning step there may be needed preparatory steps. There are foils which are parts to be attached to the base foil in order to produce the patterning, and there are printing screens through which the patterns are to be screen printed onto the base foil using the appropriate inks:” Further down at line 15, “the patterning step may comprise any form of patterning, including but not being limited to screen printing, offset printing, digital printing, etching, holographic picture generation, painting, sputtering, plating, perforating, gluing and placing stickers on to the base foil.”

U.S. Pat. No. 6,454,984 discloses a molding die of laminated molding and manufacturing method of laminated molding. The molding die has compressible surface members which are partially laminated, where a flow regulating portion regulates molten resin flowing toward the surface members. The resin laps at an end portion of the surface members and [because of a?] position shift of the surface members by the flow of the resin, laminated molding having good quality and appearance can be obtained. As seen in the Disclosure of the Invention section around line 26, “the present invention is characterized in having: a die body having in the die body and being advanceable and retractable relative to the cavity; and a flow regulating portion provided to the die body for regulating flow of the molten resin flowing toward the surface member.” Further down at line 41, “accordingly, resin lap where the peripheral end of the surface member is turned over or buried in the resin by the flow of the molten resin, or position shift of the surface member by the resin flow can be prevented.”

U.S. Pat. No. 6,257,866 discloses an apparatus for accurately forming plastic sheet, where a sheet of thermo formable plastic material is positioned by air pressure adjacent to a planar surface of a heating plate to heat and soften the sheet. The sheet is draped over a mold by the force of air pressure to form a molded part on cooling. A plurality of sheets may be fused with one another during the heating of the sheets. In the Summary of the Invention section as seen in column 2 around line 4, “another object of the present invention is to provide an apparatus for heating sheet material during a thermal forming process without permitting the sheet material to sag during the heating process.”

Referring to column 7 around line 19, “for example, UV resistant sheet material may be fused over a sheet having printed graphics thereon to protect such graphics against deterioration by UV radiation. For in-mold decoration (IMD), a sheet to become an IMD insert can have printed or other graphics placed thereon protected by fusing or bonding a sheet of plastic material there over. Thereafter, the IMD insert can be used in the conventional injection molding process without fear of distortion or damage to the printing or the graphics on the IMD insert.”

U.S. Pat. No. 4,369,157 discloses a method of automatically decorating articles as they are in mold formed automatically, wherein elongated tape or a strip of decorating material is automatically advanced and pre-fed and positioned in the mold at each molding cycle, interfacing therein automatically with plastics as they fill the molds under heat and pressure; as the article is thus formed, the decorating material forms therewith a unitary permanent decorating part.

### BRIEF DESCRIPTION OF THE DRAWINGS

FIG. 1 is a schematic flow chart of the IML/IML formation process;

FIG. 1A is a schematic sub flow chart of a process to prepare an inlay;

FIG. 1B is a schematic sub flow chart of a process to load inlays;

FIG. 1C is a schematic sub flow chart of a process to form a decoration part;

FIG. 1D is a schematic sub flow chart of a process to eject a part;

FIG. 2 is a schematic flow chart of an IMD/IML process;

FIG. 2A is a schematic sub flow chart of a process to prepare foil and decorations;

FIG. 2B is a schematic sub flow chart of a process to load decorations;

FIG. 3 is a cross sectional view of an IMD/IML decoration and mold;

FIG. 3A is a schematic detail view of a foil and decoration;

FIG. 4 is a cross-sectional view of an IMD/IML decoration and mold;

FIG. 5 is a cross-sectional view of an IMD/IML decoration and mold;

FIG. 6 is a cross-sectional view of an IML/IML decoration and mold;

FIG. 7 is a cross-sectional view of an IML/IML decoration and mold;

FIG. 8 is a cross-sectional view of an IML/IML decoration and mold.

### DESCRIPTION OF THE PREFERRED EMBODIMENTS

The present concept utilizes a process to integrate an in-mold decoration with a part. The part can be any outer body or interface of consumer electronic, computer peripheral, automotive interior, cell phone, or other digital device. The in-mold decoration can be in the form of a laminate applied to the outer surface of the part or a decoration of ink or other graphic art provided onto the part by a foil carrier.

The laminate is referred to as in-mold laminate or IML. The art decoration is referred to as an in-mold decoration or IMD. Various processes for forming the in-mold decorated part will be discussed. Before discussing the formation process, a discussion of the molds, the parts, and the decorations will be provided.

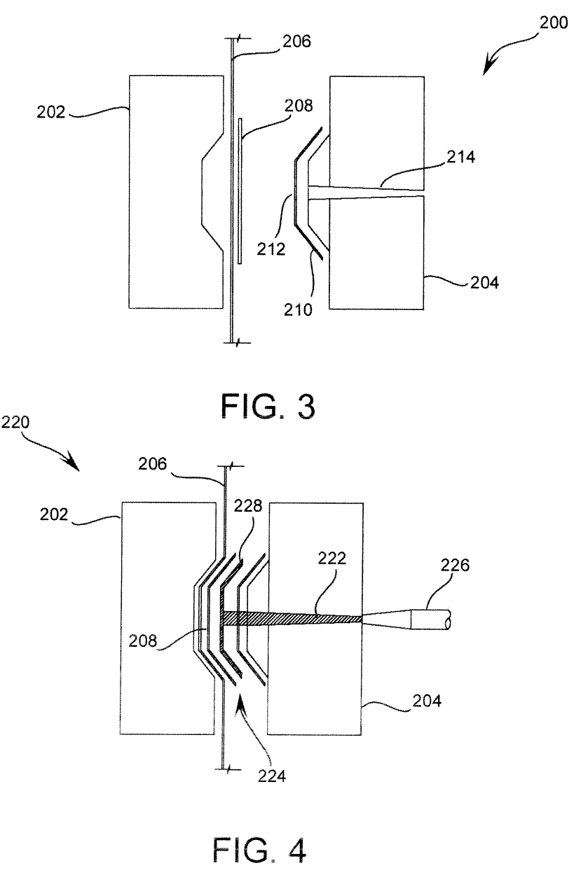

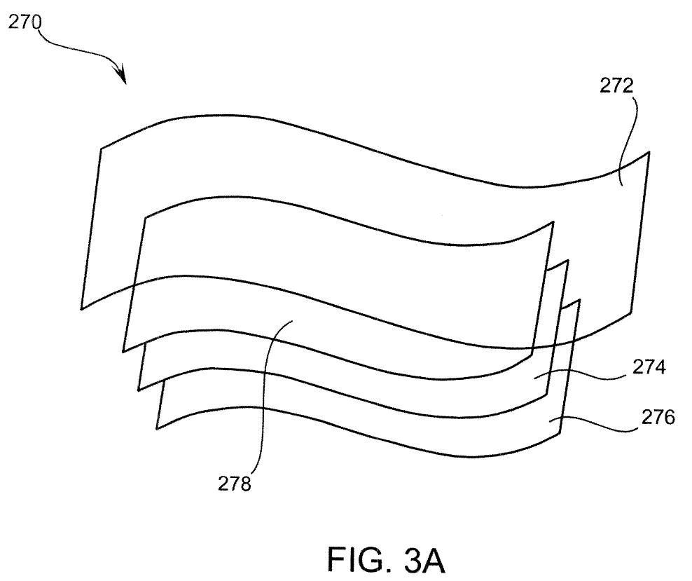

Referring to FIG. 3, an IMD/IML decoration mold 200 is provided. In this particular embodiment, the IMD/IML decoration mold 200 has a first mold half 202 and a second mold half 204. The first mold half 202 is a moving mold half, while the second mold half 204 is a fixed mold half.

The fixed mold has the injection channel 214 for providing the later discussed resin for forming the part. In this particular arrangement, a foil carrier 206 has been prepared with art decoration 208. The foil carrier 206 and decoration 208 are located, aligned, and placed adjacent to the first mold half 202.

Opposing the decoration 208 is an inlay 210. The inlay 210 has been prepared with an image or color on its inner surface, as well as with through ports for the various boss snaps of the part as well as an inlay gate through port 212 for the transfer of the resin through the inlay into the mold cavity to be discussed below.

Generally speaking the part is formed using a molding resin such as a polycarbonate resin, polypropylene, polylactic acid, acrylic resin, acrylanitrilestyrene resin, SAN, acrylanitrilebutadene styrene (ABS) resin, TPU, or a polymer alloy of the previously mentioned resins.

Referring to FIG. 3A, the IMD portion of the decoration includes a foil and decoration component 270. A foil carrier 272 carries a hard coat layer 274 which provides for the outer finished surface of the parts, as well as a second color layer and adhesive layer 276.

Separating the hard coat layer 274 from the foil carrier 272 is a release layer 278. The adhesive layer 276 combined with the color portion sets the color into the part during forming of the part to be discussed below.

Examples of materials for the foil carrier 272 include preferably a polyester base resin, but may also include a vinylchloride base resin, acrylic based resin, polycarbonate, polypropylene, polyethylene, polyurethane, polystyrene, acetate, polymyde, etc.

The foil carrier 272 is formed through a method such as casting but may also include: extrusion, calendaring, etc. The thickness of the foil carrier 272 may vary, one range is from 5 micrometers to 5 mm, with a preferable thickness at 50 micrometers. The release layer 278 can be a melamine based resin, a silicone, a fluorine, and alkyd, a phenolic, or other suitable release based material.

In order to form the release layer, a printing method can be used such as traditional gravure printing, offset printing, screen printing as well as other printing methods. The other methods can include painting, dipping, or a reverse coating process.

The hard coat 274 which is formed on top of the release layer 278 is made of an acrylic based resin material, but may also include: polyester base resin; vinyl base resins; nitrocellulose based resins; urethane base resins; and chlorinated rubber based resins.

While the hard coat layer 274 may be made of a resin, it can also be made of materials such as metal film including aluminum, chromium, copper, nickel, indium, tin, oxide silicone etc. While the hard coat layer 274 in the finished part state is on the outside surface of the part, its thickness is dependent upon the final design. The thickness of the hard coat layer may be between 0.5 micrometers and 50 micrometers. This depends upon the desired fit and finish of the part, and the thickness may be more or less than the range given.

If a metal film is used, the thickness may be 150 Angstroms to 1200 Angstroms. In preparing the hard coat layer 274, printing methods such as offset printing, gravure printing, screen printing or other methods including painting, dip coating, and a reverse coating process may be employed. Forming a metal film layer includes processes such as vacuuming, plating etc.

In order to set the color or the various patterns for the decoration, the patterns being decorated may include patterns for automotive use, cell phone use, consumer electronics, and other graphical images to represent faux designs or realistic representations of natural materials or artificial componentry; the patterns or colors are mixed with an adhesive to form a color adhesive layer 276 which is laid on the hard coat layer 274 prior to formation with the part.

Examples for use in the color and adhesive layer 276 include an acrylic based resin, a vinyl based resin, a urethane based resin, a polyester based resin, a polypropylene based resin, a polyethylene based resin, a polystyrene based resin, a polycarbonate based resin, a polyvinyl alcohol based resin, an acetate based resin, and a polymide based resin, all suitable for combining with the appropriate molding resin.

To install the color and adhesive layer 276, various printing methods such as gravure printing, offset printing, screen printing, painting, dipping, and reverse coating process may be employed.

Referring back to FIG. 3, a discussion of the inlay 210 will now be provided. The inlay 210 has been configured, in this particular arrangement, for the inside face of the part, and is made of a polycarbonate material, with an ink layer on the parts surface facing portion of the inlay 210 which contains the desired images.

The forming of the inlay 210 starts with the preparation of the image in a pre-molded state in preparation for deformation to its final molded state. The graphic images printed on the sheet using the previously mentioned methods of for example: gravure printing, offset printing, screen printing, painting, vacuum metalization. The inlay 210 first may start as an entire sheet of film, which is then printed on with multiple arrays of the same image of the individual part.

The inlay 200 is then routed or cut out of the original sheet and the inlay is then placed robotically in position next to the second mold half 204 surface. The inlay 210 is maintained against the second mold half surface 204 through the use of one or more of the following: suction, mechanical means, thermal differential, etc . . .

Prior to placing of the inlay within the second mold half 204, the inlay 210 may be embossed in a pre-forming/embossing or etching process. This process may include either a heat/cooling thermal process on a mold, relief, or a stamping/mechanical/embossing process on a mold relief.

Once the decoration and foil carrier 206 and 208, as well as the inlay 210 have been positioned within the cavity region of the mold for the IMD/IML decoration 220, (referring to FIG. 4), the mold halves are closed in preparation for injection of the resin.

The mold halves are closed as seen in FIG. 4, where the first mold half 202 and the second mold half 204 are maintained against one another and form a mold cavity 224. The foil carrier 206 and decoration 208 are deformed to the desired part configuration state, and the inlay 210 is also maintained in its position.

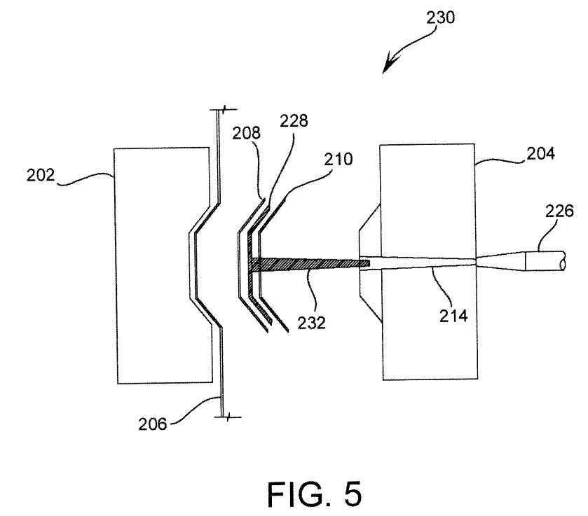

The part resin 222 is injected by the injection machine 226 and in this particular embodiment a one-shot injection process is provided. Referring to FIG. 5, with the part cooled, the decoration 208 has been formed against the outer surface of the part 228 with the inlay 210 formed on the inner surface of the part 220.

A runner 232 is provided which is the portion of the part resin through the second mold half 204 or the fixed mold where the one-shot injection took place through the injection channel 214. The finished decorated part 228 having the IMD/IML decoration is then robotically or manually removed and the mold halves are arranged for the next formation process.

A discussion of an IML/IML decoration mold 240 will now be provided. Here the part will be decorated with a first inlay 242 and a second inlay 244. The inlays are prepared as previously discussed in the above IMD/IML decoration mold section as seen in FIGS. 3-5.

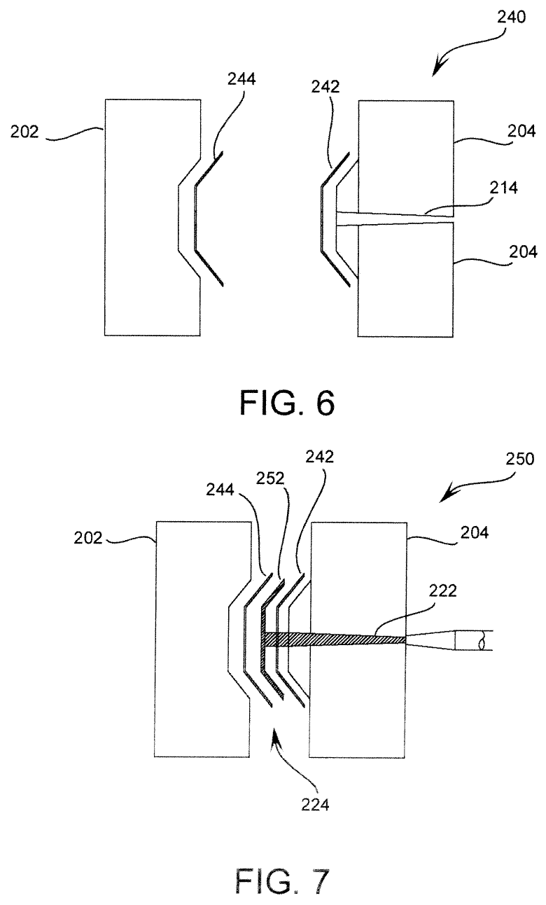

In FIG. 6, the first inlay 242 and second inlay 244 are robotically or manually placed in their positions respective to the first mold half and the second mold half. The first mold half 202 has the configuration of the outer surface of the part and may also be prepared with various through ports for the bosses as well as provided with injection ports depending on the preconfiguration of the particular part to be formed.

After the inlays are placed within the cavity between the first mold half and the second mold half, the molds are closed against one another to form an inner cavity region or mold cavity 224. The part resin 222 is injected in this particular situation in a one-shot formation process, where the part 52 is allowed to cool with the first inlay 242 on the inside portion of the part and the second inlay 244 on the outside portion of the part.

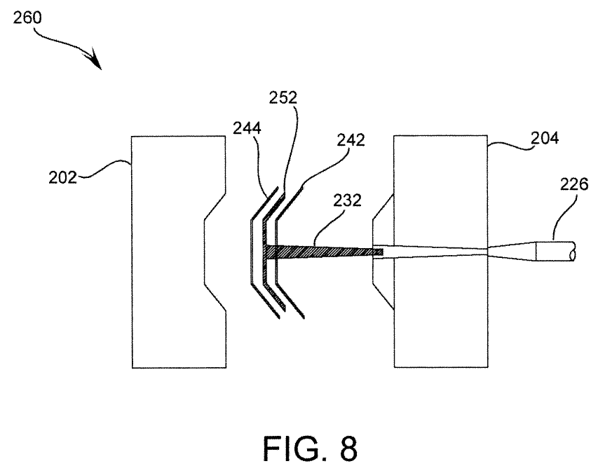

Referring to FIG. 8 once cooled, the injected IML/IML part 260 is provided with the first inlay 242 and the second inlay 244 now bound to the part 254 with a runner 232 of the part extending from the injection channel 214. The finished part is then robotically or manually removed and the mold halves are placed in preparation for the formation of the next part.

Now that the discussion of the materials and the apparatus for forming the decoration and part have been provided, a detailed discussion of various embodiments of the overall processes for forming both an IML/IML decoration part and an IMD/IML decoration part will now be provided.

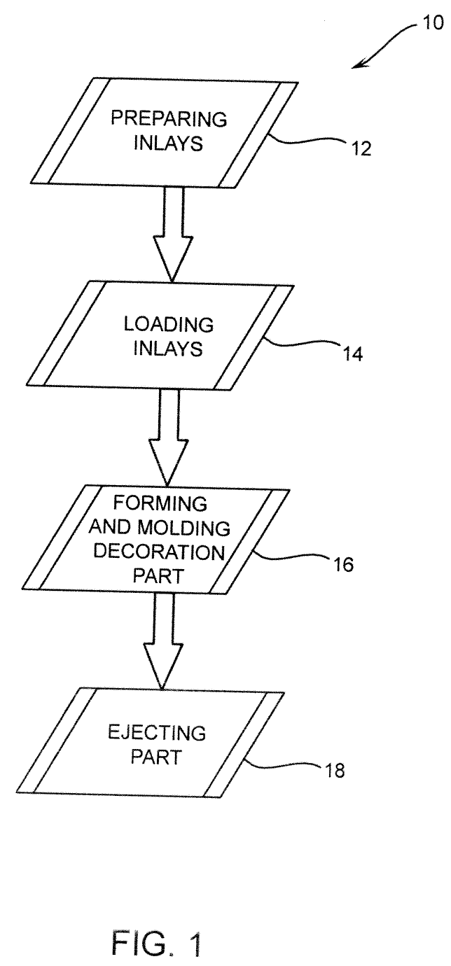

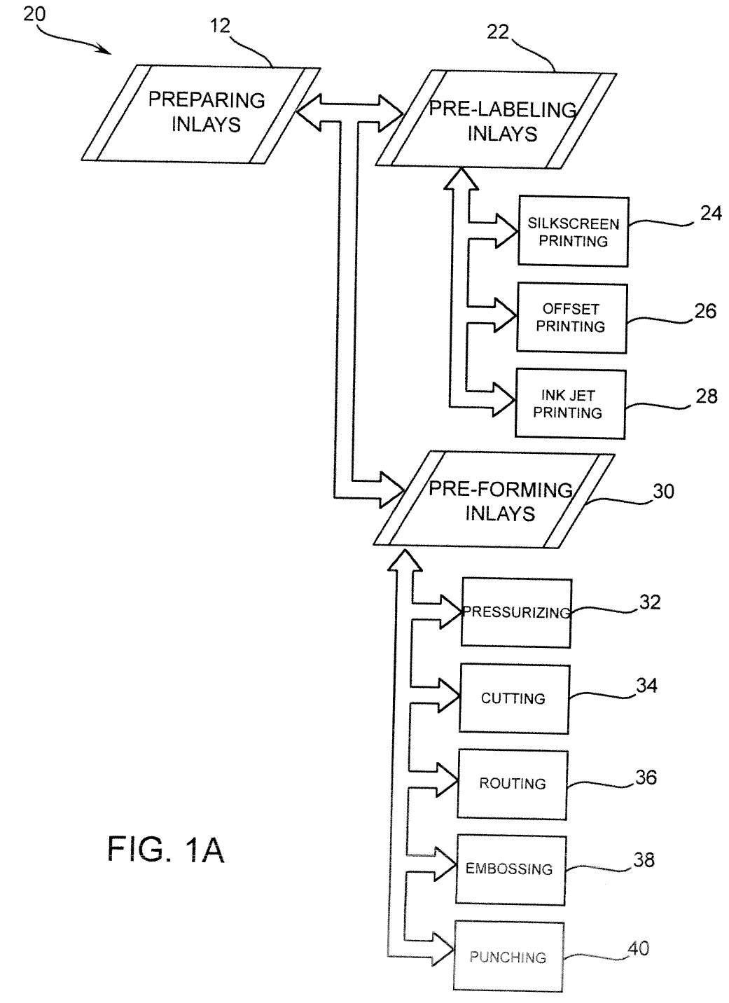

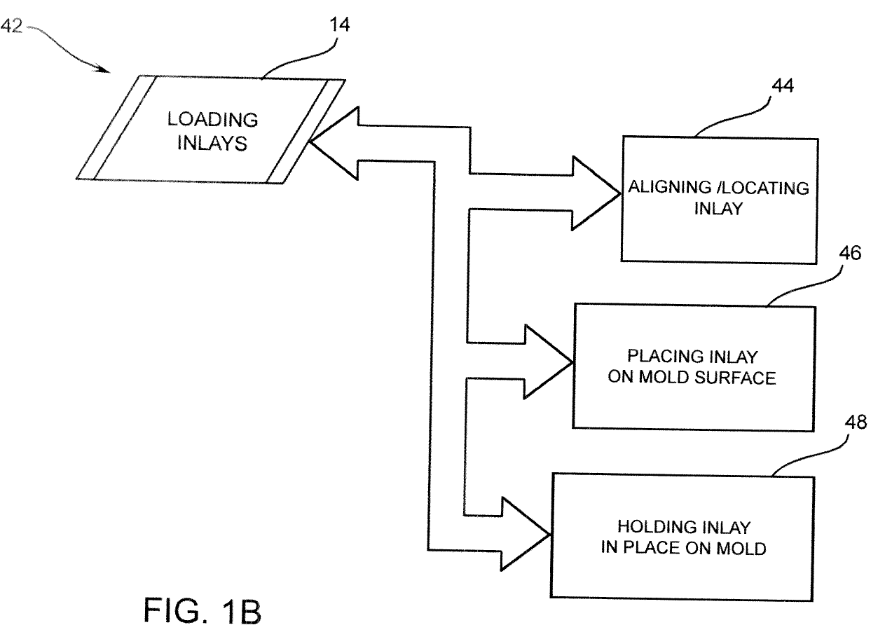

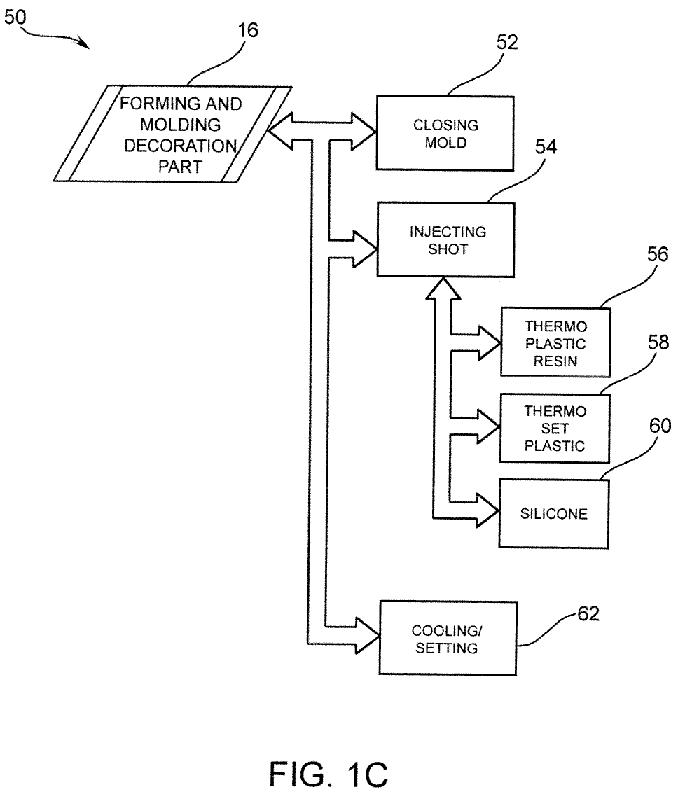

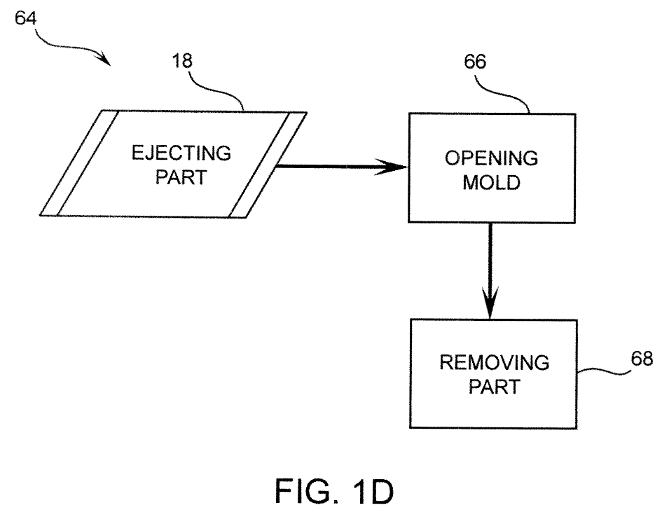

Referring to FIG. 1, an IML/IML in mold decoration formation process 10 will now be provided. The below steps are general steps with regard to the formation process and may be incorporated into one another or extrapolated from one another depending on the desired method of decoration for the in mold part. For example, the present steps in FIG. 1 as shown have sub steps in FIGS. 1A-1D which will be discussed below. In general, the processes include preparing the inlays at step 12, loading the inlays at step 14, forming the inlays in the mold with the decoration part at step 16, and then ejecting the part at step 18.

Referring to FIG. 1A, discussion of the process to prepare the inlays 20 will now be provided. In preparing the inlays at step 12, the inlays as indicated above may be pre-labeled at step 22 in an array type arrangement. The images may be laid on the sheet in one or more combinations of the below steps, such as silk screen printing at step 24, offset printing at step 26, inkjet printing at step 28, or gravure printing at step 29.

Depending on the particular part and the particular design desired for the part, the pre-labeling of the inlays at step 22 may occur first or some preforming of the inlays at step 30 may also occur.

For example, as previously discussed above in FIG. 3, the inlay 210 may be required to have for certain bosses through ports as well as injection ports 212 for extensions of connection components through the decoration to, say for example, the base layer of the cell phone part.

Thus, pre-cutting or preforming at step 30 of the inlays is a useful step in preparing the decoration for mating with the customized port. Here the inlay sheet can be routed at step 36, cut at step 34 as well as embossed at step 38 or punched at step 40.

Furthermore, pressurizing at step 32 depending on the preset thermal characteristics of the underlying preforming surface of a relief mold may enable for example the polycarbonate film material to be slowly deformed without significantly deforming the pre-printed ink layer which has been prepared for the mold and is in a pre-adhesive combined state.

Once the inlay has been prepared at step 12 (referring back to FIG. 1), the inlay can be loaded at step 14 into the first mold half 202 and second mold half 204 as previously discussed above. Referring to FIG. 1B, a discussion will provide now for the process to load the inlays 42.

The loading inlay step 14 includes the following substeps: the inlay 210 must first be aligned with the fixed or moving mold at step 44. Here either a form of robotic arm, film carrier or manual placement is utilized. The inlay is then placed on the mold surface at step 46.

The inlay is then held in place on the mold at step 48 using various forms of temporary adhesion such as a differential in pressure caused by a surface temperature difference between the mold surface and the ambient air temperature at the inlay surface, a vacuum provided within the mold at predetermined locations for maintaining holding points of the inlay against the surface of the mold cavity, or robotic apertures which maintain the inlay in its position.

At step 14, with the inlays loaded into the first mold half and the second mold half; the inlays are ready for the process to form the decoration part at step 50 as seen in FIG. 1C. Here the forming and molding of the decoration part at step 16 is provided. The mold is first closed at step 52 and then the injecting of the mold halves occurs at step 54 through the injection channel 214 as previously discussed in FIG. 4.

While a one-shot injection process has been provided, more than one shot may be provided depending on the number of cavities within the mold as well as number of materials required for formation of the part. In this particular embodiment, a thermoplastic resin is injected at step 56. As previously discussed, the resin can be an acrylic, an acrylon nitrile, a styrene resin, an acylebetedyne, polycarbonate, or a PMMA.

While not generally used, also a thermoset plastic at step 58 may be provided where a chemical reaction occurs in lieu of a thermal reaction. Additionally, a silicone component at step 16 may be provided, the silicone being of either a silicone carbonate-type nature or a softer form of silicone such as the forms used in medical devices.

Once the mold has been injected with the resin, the inlays 210 at step 62 are set to the mold part and are allowed to cool with the mold. Referring to FIG. 1D, after cooling has taken place, the process to eject the part at step 64 is provided where at step 18 ejecting the part includes opening the mold at step 66 and removing the part at step 68. The mold is opened at step 66 through actuation of the moving mold or in this particular embodiment, the first mold half 202, and the robotic arms or manual removal of the part occurs at step 68 by grabbing for example the runner 232 of the part as previously discussed.

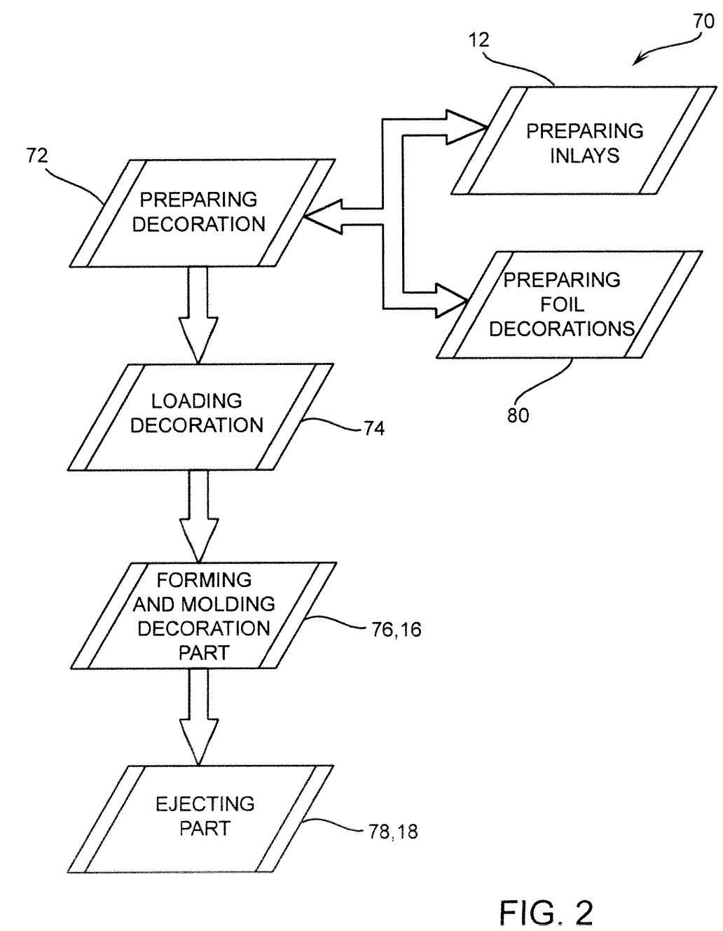

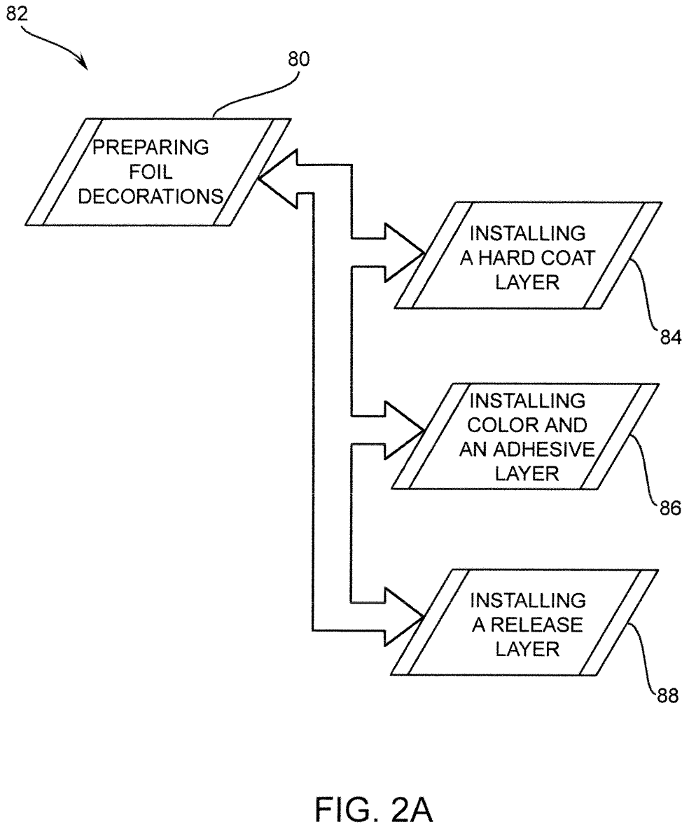

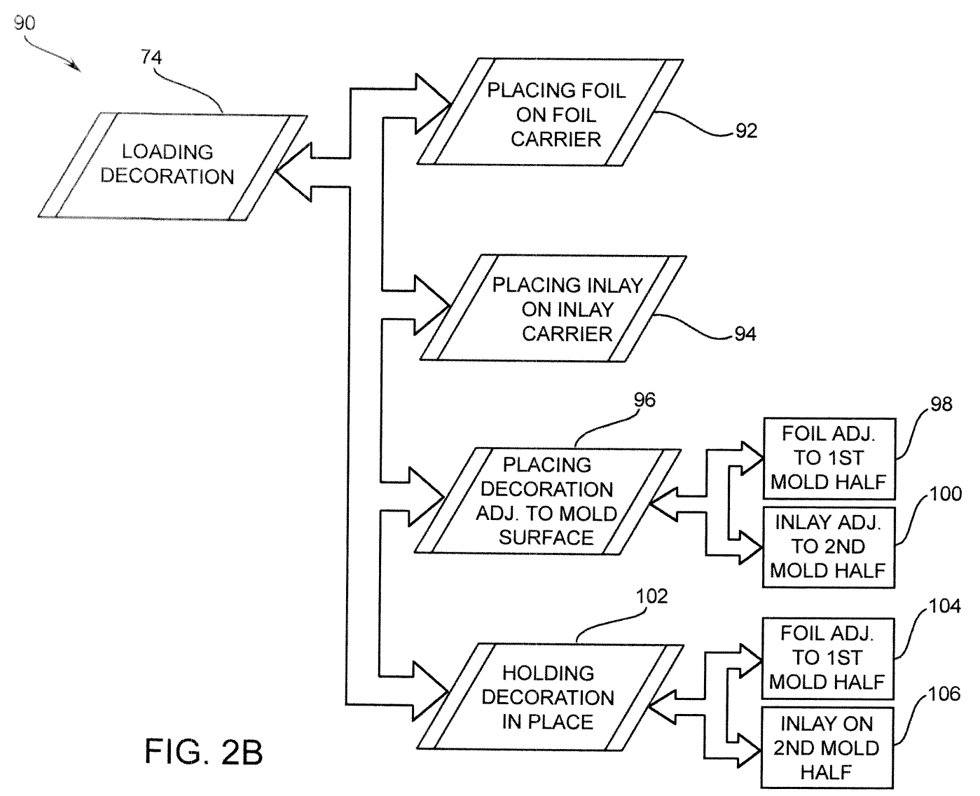

A discussion of the IMD/IML process 70 will now be provided as seen in FIG. 2. General steps for the IMD/IML process include preparing the decoration at step 72, loading the decoration at step 74, forming the decoration of the part at step 76, and ejecting the part at step 78. In preparing the decoration at step 72, the decoration refers to either the inlay 210 or the decoration 208 carried on the foil carrier 206 as previously discussed in FIG. 3. Preparing the inlays takes the same process as seen previously in step 12 (FIGS. 1 and 1A), while preparing foil decorations at step 80 will now be discussed.

Referring to FIG. 2A, a process to prepare foil decorations 82 will now be provided. Preparing foil decorations at step 80 includes the following steps:

First, a release layer at step 88 must be installed so that after binding of the decoration to the resin of the part, the foil carrier is removed. The installation of the release layer at step 88 onto the foil carrier prior to the installation of the hard coat layer is accomplished through the use of printing methods such as gravure printing, offset printing, screen printing, painting, dip coating, reverse cutting etc.

Next, a hard coat layer is installed onto a foil carrier at step 84. Installation of the hard coat layer as previously discussed onto the foil carrier 272 can take the form of the following installation steps, none of which are exclusive: printing methods such as gravure printing, offset printing, screen printing, painting, dip coating, or reverse coating may be employed. To form a metal layer, vacuum deposition or plating may also be employed.

Once the release layer 88 and hard coat layer are installed at steps 88 and 84, a color and adhesive layer can be installed at step 86. In order to install the adhesive layer, printing methods can be used such as gravine printing, offset printing, screen printing, painting, dip coating, etc.

With the incorporation of the foil decorations at step 80 complete, the decorations are then loaded at step 74 as previously discussed in FIG. 2. Referring to FIG. 2B, a process to load the decoration 90 is provided. Here at the decoration loading at step 74 includes either placing the foil with decoration on a foil carrying sheet at step 92 or directly imprinting the decorations onto the foil carrying sheet itself, thus removing a component of the process.

The foil carrying sheet is part of a mechanized indexing system to load in place the decoration in proper alignment with the mold cavity. In this particular embodiment, the foil carrying sheet may be configured similarly to the previously discussed inlays which were routed for the boss ports and injection channel ports.

In doing so, the ability to provide the foil carrier 206 and the decoration 208 on the inside face, or in this particular embodiment, the second mold half 204, (being fixed with the injection port channels 214) is accomplished. Reinforcement of the foil sheet carrier 206 may be needed for high velocity indexing runs to avoid tearing at the bossed through ports and injection port critical edges.

In an alternative embodiment, the foil carrying sheet 206 and the decoration 208 may also be provided at the embossed mold half or in this particular embodiment, the first mold half 202. With the decoration placed on the foil carrying sheet at step 92, the inlay is arranged on an inlay carrier at step 94. The inlay carrier may be a robotic arm device, a transient sheet carrying device, or a manual component.

Next the decorations (meaning the inlay and the decoration on the foil), are placed adjacent to the mold surfaces at step 96. The foil in this particular embodiment is placed adjacent to the first mold half at step 98 and the inlay is placed adjacent to the second mold half at step 100.

With the decorations now located in the proper position within the mold cavity, the decorations are held in place at step 102 with the foil being maintained adjacent to the mold half at step 104 and in an alternative embodiment being pressurized within the mold cavity, robotically maintained within the mold cavity, or maintained thermally or through a vacuum pressure at the proper location. Similarly, the inlay is maintained on the second mold half at step 106 through pressure, thermal or fluid pressure that is, vacuum pressure, or a robotic mechanism.

With the loading of the decorations at step 74 complete, the forming of the mold with decoration part at step 76 as previously discussed in FIG. 2 can take place. The same process as the forming and molding of the decoration part at step 16 as seen in FIG. 1C is utilized. Once the cooling of the part and the setting of the decorations takes place at step 62, the part can be ejected at step 78, FIG. 2, which is the same process as seen in FIG. 1D at step 18. With the part removed at step 68, the next decoration can be loaded into the mold for forming of the part.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A method for forming an IML/IML in mold decoration part, said method comprising:
a. preparing a first inlay and a second inlay, said first inlay comprising a first film and a first image, said second inlay comprising a second film and a second image;
b. loading said first inlay and said second inlay into a plastic injection mold, said plastic injection mold comprising a first mold half and a second mold half;
c. forming a decoration part within said mold with said first inlay and said second inlay;
d. ejecting said decoration part with said first inlay and said second inlay maintained on said decoration part.

2. The method according to claim 1 wherein said preparing said first inlay and said second inlay further comprises:
a. pre-labeling said first inlay and said second inlay;
b. preforming said first inlay and said second inlay.

3. The method according to claim 2 wherein said pre-labeling said first inlay and said second inlay further comprises: utilizing a silkscreen printing process.

4. The method according to claim 2 wherein said pre-labeling said first inlay and said second inlay further comprises: utilizing an offset printing process.

5. The method according to claim 2 wherein said pre-labeling said first inlay and said second inlay further comprises: utilizing an inkjet printing process.

6. The method according to claim 2 wherein said pre-labeling said first inlay and said second inlay further comprises: utilizing a gravure printing process.

7. The method according to claim 2 wherein said pre-forming said first inlay and said second inlay further comprises: utilizing a cutting process to form said first inlay and said second inlay.

8. The method according to claim 2 wherein said pre-forming said first inlay and said second inlay further comprises: utilizing a routing process to form said first inlay and said second inlay.

9. The method according to claim 2 wherein said pre-forming said first inlay and said second inlay further comprises: utilizing and embossing process to form said first inlay and said second inlay.

10. The method according to claim 2 wherein said pre-forming said first inlay and said second inlay further comprises: utilizing a punching process to form said first inlay and said second inlay

11. The method according to claim 2 wherein said preforming said first inlay and said second inlay further comprises: utilizing a pressurizing process to form said first inlay and said second inlay.

12. The method according to claim 1 wherein said loading said first inlay and said second inlay into said mold further comprises:
a. aligning said first inlay with said first mold half; aligning said second inlay with said second mold half;
b. placing said first inlay adjacent to said first mold half surface; placing said second inlay adjacent to said second mold half;
c. holding said first inlay against said first mold half; holding said second inlay against said second mold half.

13. The method according to claim 1 wherein said forming said decoration part further comprises:
a. closing said first mold half against said second mold half to create a mold cavity between said first mold half and said second mold half;
b. injecting a first shot of part resin into the said mold cavity;
c. setting said first inlay and said second inlay with said part resin in said mold cavity;
d. cooling said first inlay and said second inlay with said part resin in said mold cavity.

14. The method according to claim 13 wherein said injecting a first shot of part resin further comprises: injecting a thermal plastic resin into said mold cavity.

15. The method according to claim 13 wherein said injecting a first shot of part resin further comprises: injecting a thermoset plastic resin into said mold cavity.

16. The method according to claim 13 wherein said injecting a first shot of part resin further comprises: injecting a silicon carbon based material in to said mold cavity.

17. The method according to claim 1 wherein said ejecting said part further comprises: opening said mold halves, removing said part with said first inlay and said second inlay attached to said part.

18. A method for forming in IMD/IML decoration part, said method comprising:
a. preparing a decoration for insertion into a plastic injection mold, said decoration comprising a first inlay, a first foil decoration;
b. loading said decoration into said plastic injection mold, said plastic injection mold comprising a first mold half and a second mold half;
c. forming a decoration part within said mold with said decoration and a part resin injected into said plastic injection mold;
d. ejecting said decoration part with said decoration maintained on said decoration part.

19. The method according to claim 18 wherein said preparing a decoration further comprises: preparing said foil decoration by:
a. installing a release layer onto a foil carrier;
b. installing a hardcoat layer onto said release layer;
c. installing a color and adhesive layer onto said hardcoat layer.

20. The method according to claim 18 wherein said preparing a decoration further comprises preparing a foil carrier comprising the steps of:
a. pressurizing said foil carrier to form a relief on said carrier foil;
b. cutting said foil carrier to form a foil carrier shape;
c. routing said foil carrier to form a foil carrier through port;
d. puncturing said foil carrier to form a foil carrier through port;
e. reinforcing said foil carrier to resist tearing of said foil carrier during forming of the IMD/IML in-mold decoration part.

21. The method according to claim 18 wherein said preparing said first inlay further comprises:
a. pre-labeling said first inlay;
b. preforming said first inlay.

22. The method according to claim 21 wherein said pre-labeling said first inlay further comprises: utilizing a silkscreen printing process.

23. The method according to claim 21 wherein said pre-labeling said first inlay further comprises: utilizing an offset printing process.

24. The method according to claim 21 wherein said pre-labeling said first inlay further comprises: utilizing an inkjet printing process.

25. The method according to claim 21 wherein said pre-labeling said first inlay further comprises: utilizing a gravure printing process.

26. The method according to claim 21 wherein said pre-forming said first inlay further comprises: utilizing a cutting process to form said first inlay.

27. The method according to claim 21 wherein said pre-forming said first inlay further comprises: utilizing a routing process to form said first inlay.

28. The method according to claim 21 wherein said pre-forming said first inlay further comprises: utilizing an embossing process to form said first inlay.

29. The method according to claim 2 wherein said pre-forming said first inlay further comprises: utilizing a punching process to form said first inlay.

30. The method according to claim 21 wherein said preforming said first inlay further comprises: utilizing a pressurizing process to form said first inlay.

31. The method according to claim 18 wherein loading said decoration further comprises:
a. arranging said foil on said foil carrier sheet;
b. placing said inlay on an inlay carrier;
c. arranging said decoration adjaced to said first mold half and said second mold half by:
d. aligning said first inlay with said first mold half; aligning said first foil decoration with said second mold half;
e. holding said first inlay adjacent to said first mold half surface and said first fold decoration adjacent to said second mold half.

32. The method according to claim 31 wherein said forming said decoration part further comprises:
a. closing said first mold half against said second mold half to create a mold cavity between said first mold half and said second mold half;
b. injecting a first shot of a part resin into the said mold cavity;
c. setting said first inlay and said first decoration with said part resin in said mold cavity;
d. cooling said first inlay and said first decoration with said part resin in said mold cavity.

33. The method according to claim 32 wherein said injecting a first shot of part resin further comprises: injecting a thermal plastic resin into said mold cavity.

34. The method according to claim 32 wherein said injecting a first shot of part resin further comprises: injecting a thermoset plastic resin into said mold cavity.

35. The method according to claim 32 wherein said injecting a first shot of part resin further comprises: injecting a silicon carbon based material in to said mold cavity.

36. The method according to claim 32 wherein said ejecting said part further comprises: opening said mold halves, removing said part with said first inlay and said first decoration attached to said part.

37. A method for forming an IML/IML in mold decoration part, said method comprising:
a. preparing a first inlay and a second inlay, said first inlay comprising a first film and a first image, said second inlay comprising a second film and a second image; said preparing said first inlay and said second inlay further comprising:
i. pre-labeling said first inlay and said second inlay;
ii. preforming said first inlay and said second inlay;
b. loading said first inlay and said second inlay into a plastic injection mold, said plastic injection mold comprising a first mold half and a second mold half; said loading said first inlay and said second inlay into said mold further comprising:
i. aligning said first inlay with said first mold half; aligning said second inlay with said second mold half;
ii. placing said first inlay adjacent to said first mold half surface; placing said second inlay adjacent to said second mold half;
iii. holding said first inlay against said first mold half; holding said second inlay against said second mold half;
c. forming a decoration part within said mold with said first inlay and said second inlay; said forming said decoration part further comprising:
i. closing said first mold half against said second mold half to create a mold cavity between said first mold half and said second mold half;
ii. injecting a first shot of part in person into the said mold cavity;
iii. setting said first inlay and said second inlay with said particular resin and said mold cavity;
iv. cooling said first inlay and said second inlay with said Art Rosen and said mold cavity;
d. ejecting said decoration part with said first inlay and said second inlay maintained on said decoration part; said ejecting said part further comprising: opening said mold halves, removing said part with said first inlay and said second inlay attached to said part.

38. A method for forming in IMD/IML decoration part, said method comprising:
a. preparing a decoration for insertion into a plastic injection mold, said decoration comprising a first inlay, a first foil decoration;
b. said preparing a decoration further comprising: preparing said foil decoration by:
i. installing a release layer onto a foil carrier;
ii. installing a hardcoat layer onto said release layer;
iii. installing a color and adhesive layer onto said hardcoat layer;
c. said preparing a decoration further comprising: preparing a foil carrier comprising the steps of:
i. pressurizing said foil carrier to form a relief on said carrier foil;
ii. cutting said foil carrier to form a foil carrier shape;
iii. routing said foil carrier to form a foil carrier through port;
iv. puncturing said foil carrier to form a foil carrier through port;
v. reinforcing said foil carrier to resist tearing of said foil carrier during forming of the IMD/IML in-mold decoration part;
d. said preparing said first inlay further comprising:
i. pre-labeling said first inlay;
ii. preforming said first inlay;
e. loading said decoration into said plastic injection mold, said plastic injection mold comprising a first mold half and a second mold half; said loading said decoration further comprising:
i. arranging said foil on said foil carrier sheet;
ii. placing said inlay on an inlay carrier;
iii. arranging said decoration adjaced to said first mold half and said second mold half by:
iv. aligning said first inlay with said first mold half; aligning said first foil decoration with said second mold half;
v. holding said first inlay adjacent to said first mold half surface and said first fold decoration adjacent to said second mold half;
f. forming a decoration part within said mold with said decoration and a part resin injected into said plastic injection mold; said forming said decoration part further comprising:
i. closing said first mold half against said second mold half to create a mold cavity between said first mold half and said second mold half;
ii. injecting a first shot of a part resin into the said mold cavity;
iii. setting said first inlay and said first decoration with said part resin in said mold cavity;
iv. cooling said first inlay and said first decoration with said part resin in said mold cavity;
g. ejecting said decoration part with said decoration maintained on said decoration part; said ejecting said part further comprising: opening said mold halves, removing said part with said first inlay and said first decoration attached to said part.
i.
